(19) United States
(12) Patent Application Publication
(10) Pub. No.: US 2023/0214680 A1
(43) Pub. Date: Jul. 6, 2023

(54) CONTRASTIVE EXPLANATIONS FOR HIERARCHICAL RULE-BASED DECISION POLICIES

(71) Applicant: International Business Machines Corporation, Armonk, NY (US)

(72) Inventors: Jean-Michel Gerard, Bernard Bernelas, Nice (FR); Stephane Hillion, Antibes (FR); Ulrich Martin Junker, Antibes (FR); Thierry Kormann, Valbonne (FR)

(73) Assignee: International Business Machines Corporation, Armonk, NY (US)

(21) Appl. No.: 17/570,102

(22) Filed: Jan. 6, 2022

(51) Int. Cl. G06N 5/02

(52) U.S. Cl. CPC G06N 5/025

(57) ABSTRACT

An embodiment includes receiving an explanation request that includes an undesired output resulting from an input case of a hierarchical rule-based decision policy specified by an acyclic dependency graph, and further includes an alternative desired output from the hierarchical rule-based decision policy. The embodiment also includes computing a network of intermediate explanations for required ranges of respective decision nodes that achieve the desired output from the hierarchical rule-based decision policy. The embodiment also includes computing a user-facing explanation that includes a range constraint for achieving the desired output by aggregating the intermediate explanations. The embodiment also includes transmitting, as a response to the explanation request, an explanation for achieving the desired output from the hierarchical rule-based decision policy based on the user-facing explanation.

### BACKGROUND

The present invention relates generally to a method, system, and computer program product for data processing. More particularly, the present invention relates to a method, system, and computer program product for providing contrastive explanations for hierarchical rule-based decision policies.

There are many organizations and industries that utilize rule-based systems to automate processing of some kind. There are numerous applications for rule-based systems, such as automated systems control or determining whether to approve a loan. Other examples may include an expert rule-based system that helps a doctor choose a correct diagnosis based on a cluster of symptoms, a rule-based system that selects tactical moves to play a game. Such systems typically involve a set of rules that the system uses to make decisions for a given set of inputs or constraints. The rules may be organized in a hierarchical structure such that the result of applying one rule may determine which rule to apply next, and the outcome of the next rule may then impact the applicability of still further rules, and so on. In some cases, the rules themselves may be human-crafted or curated rules, or may include rules generated by a machine learning system.

### SUMMARY

The illustrative embodiments provide for contrastive explanations for hierarchical rule-based decision policies. An embodiment includes receiving an explanation request that includes an undesired output resulting from an input case of a hierarchical rule-based decision policy specified by an acyclic dependency graph, and further includes an alternative desired output from the hierarchical rule-based decision policy. The embodiment also includes computing a network of intermediate explanations for required ranges of respective decision nodes that achieve the desired output from the hierarchical rule-based decision policy. The embodiment also includes computing a user-facing explanation that includes a range constraint for achieving the desired output by aggregating the intermediate explanations. The embodiment also includes transmitting, as a response to the explanation request, an explanation for achieving the desired output from the hierarchical rule-based decision policy based on the user-facing explanation. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a cloud computing environment according to an embodiment of the present invention;

FIG. 2 depicts abstraction model layers according to an embodiment of the present invention;

FIG. 3 depicts a block diagram of an example service infrastructure that includes an automated decision system in accordance with an illustrative embodiment;

FIG. 4 depicts a block diagram of an example automated decision system in accordance with an illustrative embodiment;

FIG. 5 depicts a block diagram of an example dependency graph in accordance with an illustrative embodiment;

FIG. 6 depicts a data flow block diagram of an example contrastive explanation system in accordance with an illustrative embodiment;

FIG. 7 depicts an example network of intermediate explanations in accordance with an illustrative embodiment;

FIG. 8 depicts a data flow block diagram of an example recursive decision-range explainer in accordance with an illustrative embodiment;

FIG. 9 depicts a data flow block diagram of an intermediate explanation generator in accordance with an illustrative embodiment; and

FIG. 10 depicts a data flow block diagram of an explanation propagator in accordance with an illustrative embodiment.

### DETAILED DESCRIPTION

Rule-based systems have become widely used to process a large number of cases and to make decisions for each case that complies with a given set of rules. For an end user or customer, the rule-based system behaves like a black-box that does not provide a complete or detailed explanation as to why any particular decision is made. In some cases, a rule-based system may provide a high-level explanation as to why a decision was reached, but does not explain well enough to inform a user as to what changes could be made to reach a different outcome. For example, a customer ordering a computer system may simply be informed that a particular feature may not be added to the computer model they have selected, without providing any explanation as to what the customer could change to make that feature available.

Moreover, the disclosed embodiments provide explanations for modified cases that are not simply arbitrary changes of the original case, but are changes that are actually possible to construct. In some embodiments, the explanation includes step by step instructions for achieving the desired outcome by starting from the modification of the resulting decision and by determining which changes affecting intermediate decisions are required before achieving the desired change to the original case.

In some embodiments, a method and system for computing contrastive explanations is provided for explaining the outcome and alternative choices for a different desired outcome in connection with a hierarchical rule-based decision system. Such a system receives input data that is processed according to several intermediate rules in order to produce an output value representative of a resulting decision. In some embodiments, such a system is represented by an acyclic dependency graph that specifies which decisions and input data influence which other decisions. Each graph node has a set of one or more rules that are the basis of the decision for this node. It may happen that a hierarchical rule-based decision system does not output a desired decision for a given case. Given a case and a range of desired outcomes, disclosed embodiments determine one or more families of cases for which the decision system makes a desired decision. In some embodiments, these families are provided in the form of a report for a user to review. In some embodiments, the families are provided in order by the distance to the given case.

In some embodiments, certain characteristics of a given case represent options that, as a practical matter, cannot be changed to achieve an alternative, more desirable outcome. For example, for a consumer applying for an auto loan for a used car, a hierarchical rule-based decision system may initially output a first interest rate. The consumer inquires about what changes would result in a more favorable interest rate. The data input to the hierarchical rule-based decision system may have included down payment amount, length of the term of the loan, and age of the vehicle. The consumer may be able to change the down payment amount or agree to a different term, but the age of the vehicle they wish to purchase is a fixed value that cannot be changed to achieve the more desirable interest rate. In some embodiments, a contrastive explanation is generated taking into account inputs indicative of such fixed characteristics, so that the resulting contrastive explanation provides only changes to characteristics that are not fixed values to achieve the desired outcome.

In an exemplary embodiment, a contrastive explanation system generates a contrastive explanation according to a process that includes computing a network of intermediate explanation for required ranges of the decision nodes, computing a set of user-facing explanation for each intermediate explanation, and transforming the user-facing explanations for the resulting decision node into a user-understandable form depending on the user profile. A contrastive explanation, as disclosed herein, is a computer-generated explanation of how a given case (involving a set of input characteristics resulting in a given output) may be changed to achieve an alternative output by changing one or more of the input characteristics, including the specific change(s) that would need to be made to the input characteristic(s). A user-facing explanation for a required range of a decision node may be a list or explanation of range constraints referring to input data as well as range constraints referring to intermediate decision nodes.

In some embodiments, a contrastive explanation system computes a network of intermediate explanations for required ranges of the decision nodes while excluding the value of one or more of the decision nodes, e.g., decision nodes relating to characteristics that are fixed values. In some embodiments, a contrastive explanation system computes an intermediate explanation for a decision node as a conjunction of range constraints formulated over direct predecessors of the node such that the rules are making a decision within the required range if this conjunction is satisfied. In some such embodiments, the computation starts with the node for the resulting decision and its given desired range and then refines those explanations for intermediate decision nodes until the input data nodes are reached.

In some embodiments, a contrastive explanation system computes a set of user-facing explanations for each intermediate explanation. If an intermediate explanation refers to one or more input data nodes, but not to decision nodes, the contrastive explanation system treats that intermediate explanation as already constituting a user-facing explanation. Otherwise, the contrastive explanation system aggregates the user-facing explanations for the range constraints of each intermediate explanation. In some embodiments, the contrastive explanation system achieves this by taking the Cartesian product of these explanations and removing inconsistent combinations.

In some embodiments, a contrastive explanation system transforms the user-facing explanations for the resulting decision node into a user-understandable form depending on the user profile. This may include the removal of range constraints referring to intermediate decisions and an ordering of the explanations by their distance (number of changes) to the given case.

In some embodiments, if a given case satisfies the range constraints on input data, then the rules will result in decisions that satisfy the range constraints for the intermediate decision nodes and also meet the desired range of the resulting decisions. In some such embodiments, an explanation may contain details about intermediate decisions that may be interesting for an advanced user or rule author, but may be optionally be included or omitted for the end user.

In some embodiments, a contrastive explanation system computes an intermediate explanation by computing a combination of values for these nodes such that the decision will fall into the required range for the desired alternative outcome according to the rules. In some such embodiments, the contrastive explanation system uses constraint satisfaction techniques to find such a combination of values. In some embodiments, contrastive explanation system models the behavior of the rules in terms of a constraint model, constrains the decision to the required range, and constrains non-modifiable attributes of input data to their values in the given case.

In some such embodiments, the contrastive explanation system uses explanation-based generalization techniques to generalize such a combination of values into a family of combinations while guaranteeing that a required decision will be made for all combinations in this family. The family thus constitutes an intermediate explanation and can be described in terms of range constraints. Each range constraint refers to at most one decision node or input data node. In some embodiments, if a range constraint refers to a decision node, the contrastive explanation system will extract the required range for the decision node from the range constraint and compute an intermediate explanation for it.

Thus, disclosed embodiments take the rules of the hierarchical decision policy into account and are thus capable of computing families of cases that produce a desired decision instead of a single such case. Disclosed embodiments propose multiple possible changes, instead of proposing arbitrary changes of a given case, giving the end-user plausible choice(s). Each change option delimits a clear region in the case space and is described in terms of range constraints on input data. In some embodiments, instead of providing only a single options, for example outputting that a loan will be approved if the term is changed from 120 monthly payments to 180 monthly payments, the contrastive explanation system may give a range of options, for example outputting that the loan will be approved if the term is changed to any length of time longer than 175 monthly payments. Such an explanation is more meaningful to the user as it carries information about the decision boundary, i.e., the frontier in the case space between the region where the loan gets rejected and those where it gets accepted.

As the computed explanation also includes range constraints for intermediate decisions, disclosed embodiments may also reveal issues or unexpected behavior in the decision logic itself, and thus may be used to improve or enrich the decision logic. Disclosed embodiments use constraints derived from rule conditions to guide the search for the contrastive explanations rather than performing a blind exploration of the case space. As explanations are constructed from intermediate explanations involving the intermediate decisions, it is possible to understand how desired changes of the resulting decision propagate to changes of the input data. Thus, rather than being a black box, disclosed embodiments allow a user to follow step by step how the explanation is constructed. Disclosed embodiments leverage techniques from truth maintenance techniques, so rather than abstract from the semantics of intermediate explanations, disclosed embodiments perform dedicated consistency checks for combinations of those explanations that take their full semantics into account.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. The steps described by the various illustrative embodiments can be adapted for providing explanations for decisions made by a machine-learning classifier model, for example.

Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, contrastive explanations, computer readable storage medium, high-level features, training data, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefore, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

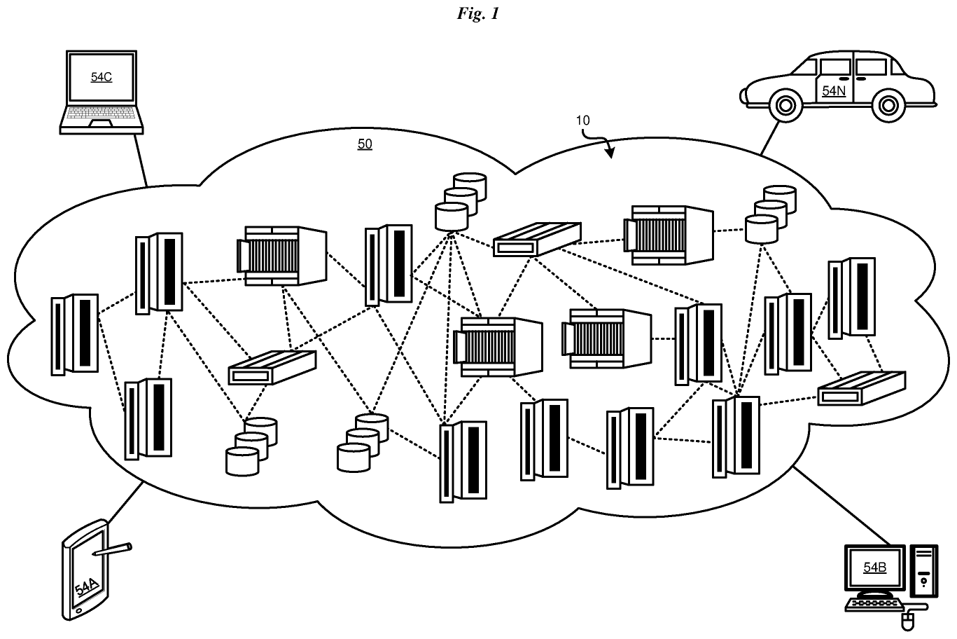

With reference to FIG. 1, this figure illustrates cloud computing environment 50. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

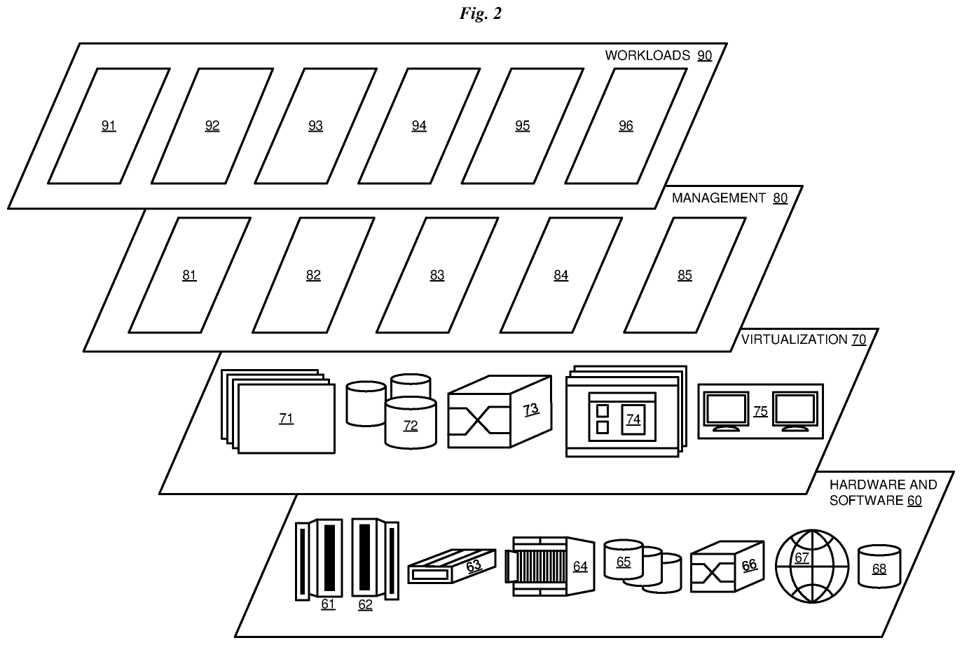

With reference to FIG. 2, this figure depicts a set of functional abstraction layers provided by cloud computing environment 50 (FIG. 1). It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and in the context of the illustrated embodiments of the present disclosure, various workloads and functions 96 for automated decision processing. In some embodiments, the workloads and functions 96 for automated decision and contrastive explanation processing also works in conjunction with other portions of the various abstractions layers, such as those in hardware and software 60, virtualization 70, management 80, and other workloads 90 (such as data analytics processing 94, for example) to accomplish the various purposes of the disclosed embodiments.

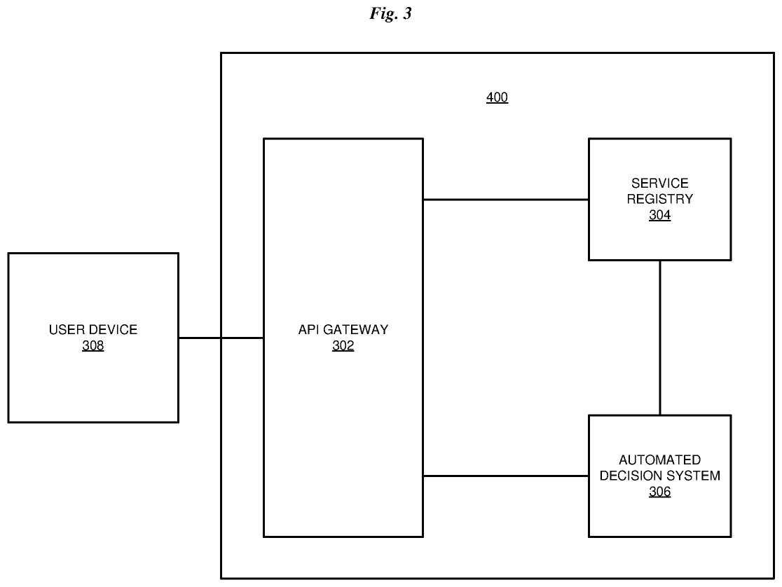

With reference to FIG. 3, this figure depicts a block diagram of an example service infrastructure 300 that includes an automated decision system 306 in accordance with an illustrative embodiment. In some embodiments, the automated decision system 306 is deployed in workloads layer 90 of FIG. 2. By way of example, in some embodiments, automated decision system 306 is implemented as automated decision processing 96 in FIG. 2.

In the illustrated embodiment, the service infrastructure 300 provides services and service instances to a user device 308. User device 308 communicates with service infrastructure 300 via an API gateway 302. In various embodiments, service infrastructure 300 and its associated automated decision system 306 serve multiple users and multiple tenants. A tenant is a group of users (e.g., a company) who share a common access with specific privileges to the software instance. Service infrastructure 300 ensures that tenant specific data is isolated from other tenants.

In some embodiments, user device 308 connects with API gateway 302 via any suitable network or combination of networks such as the Internet, etc. and use any suitable communication protocols such as Wi-Fi, Bluetooth, etc. Service infrastructure 300 may be built on the basis of cloud computing. API gateway 302 provides access to client applications like automated decision system 306. API gateway 302 receives service requests issued by client applications, and creates service lookup requests based on service requests. As a non-limiting example, in an embodiment, the user device 308 is a card reader device that executes an access routine to determine whether to grant access to a workspace in response to a sensed access card.

In the illustrated embodiment, service infrastructure 300 includes a service registry 304. In some embodiments, service registry 304 looks up service instances of automated decision system 306 in response to a service lookup request such as one from API gateway 302 in response to a service request from user device 308. For example, in some embodiments, the service registry 304 looks up service instances of automated decision system 306 in response to requests from the user device 308 related to generating an automated decision or related to generating a contrastive explanation for an alternative outcome from an automated rule-based decision system.

In some embodiments, the service infrastructure 300 includes one or more instances of the automated decision system 306. In some such embodiments, each of the multiple instances of the automated decision system 306 run independently on multiple computing systems. In some such embodiments, automated decision system 306, as well as other service instances of automated decision system 306, are registered in service registry 304.

In some embodiments, service registry 304 maintains information about the status or health of each service instance including performance information associated each of the service instances. For example, such performance information may include several types of performance characteristics of a given service instance (e.g., cache metrics, etc.). In some embodiments, the extended service registry 304 ranks service instances based on their respective performance characteristics, and selects top-ranking service instances for classification requests. In some such embodiments, in the event that a service instance becomes unresponsive or, unhealthy, the service registry will no longer provide its address or information about this service instance to other services.

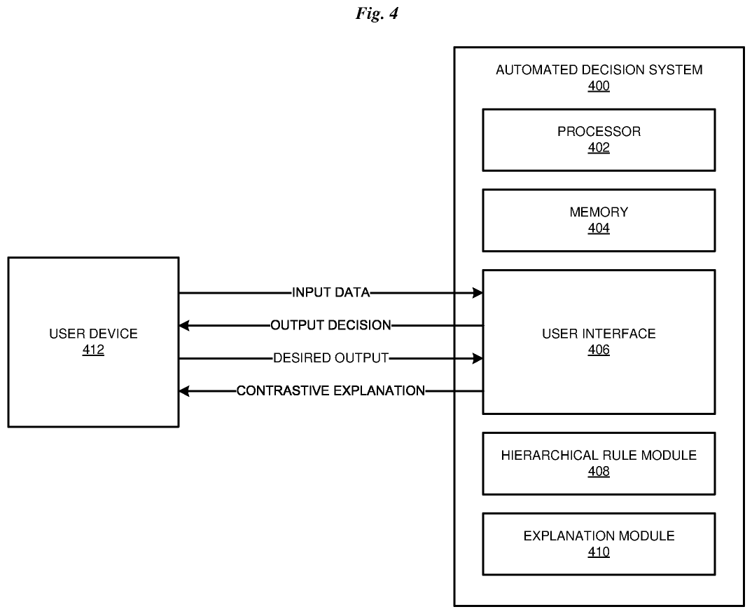

With reference to FIG. 4, this figure depicts a block diagram of an example automated decision system 400 in accordance with an illustrative embodiment. In a particular embodiment, the automated decision system 400 is an example of the workloads and functions 96 for classifier processing of FIG. 1.

In some embodiments, the automated decision system 400 includes a processor 402, memory 404, a user interface 406, a hierarchical rule module 408, and an explanation module 410. In alternative embodiments, the automated decision system 400 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the automated decision system 400 includes a processing unit (“processor”) 402 to perform various computational and data processing tasks, as well as other functionality. The processing unit 402 is in communication with memory 404. In some embodiments, the memory 404 comprises one or more computer readable storage media with program instructions collectively stored on the one or more computer readable storage media, with the program instructions being executable by one or more processors 402 to cause the one or more processors 402 to perform operations described herein.

In the illustrated embodiment, the automated decision system 400 includes a user interface 406, which may include a graphic or command line interface that allows a user to communicate with the automated decision system 400. For example, in some embodiments, the user interface 406 is configured to recognize and take action in response to requests from the user device 412 related to generating an automated decision by the hierarchical rule module 408 or related to generating a contrastive explanation by the explanation module 410 for an alternative outcome from an automated rule-based decision system. In some embodiments, a user device 412 may be any known type of computing device, such as a computer, tablet, or smart phone. In some embodiments, the user interface 406 allows communication with the user device 412 via an API gateway (e.g., API gateway 302 of FIG. 3). In some embodiments, the user interface 406 receives input data for evaluation by the hierarchical rule module 408 and outputs the resulting output decision from the hierarchical rule module 408 to the user device 412. In some embodiments, the user interface 406 receives a desired output, for example as an alternative to the output decision, for evaluation by the explanation module 410, and outputs the resulting contrastive explanation from the explanation module 410 to the user device 412.

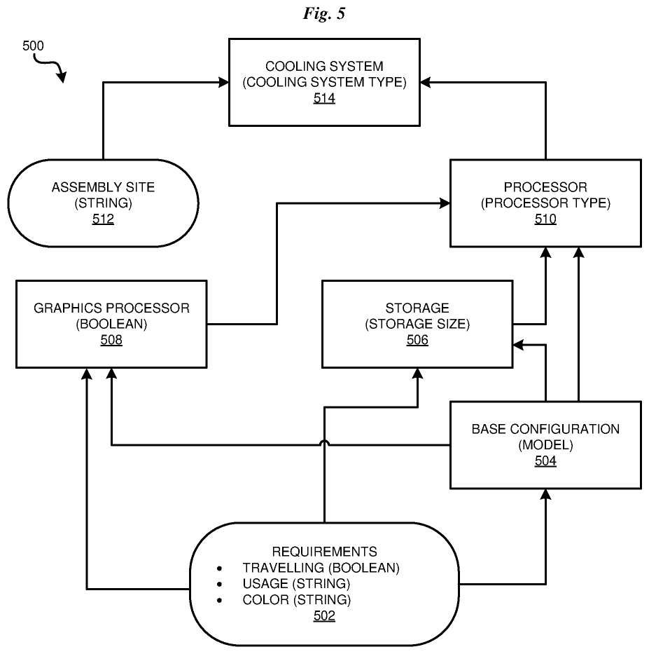

With reference to FIG. 5, this figure depicts a block diagram of an example dependency graph 500 in accordance with an illustrative embodiment. In a particular embodiment, the dependency graph 500 is a simplified example of a hierarchical rule structure such as may be used by hierarchical rule module 408 of FIG. 4.

For the sake of clarity, the operation of the disclosed contrastive explanation system and method will be described in connection with the following non-limiting example scenario. Suppose a company assembles personal computers (PCs) directly based on the requirements of the customer. The company has different assembly sites that are typically processing regional orders. Incoming orders for PCs are processed by a hierarchical rule-based PC configuration system that chooses certain components of the PC according to the requirements of the customer's order. This includes the base configuration, an optional graphic processor, the storage, the processor type, and a cooling system.

It may happen that the assembly site runs out of stock for certain components. Hence, the PC configuration needs to be validated according to the given stock. For example, an assembly site may run out of cooling systems except for liquid cooling. A modification of the given orders is needed such that the assembly unit is instructed to use a liquid cooling instead of a heatsink. This modification of the order can be achieved by a contrastive explanation system that analyses the rules of the PC configuration system.

The dependency graph 500 is a dependency graph for this simplified PC configuration problem. The case is described in terms of two input data nodes shown by rectangles with rounded corners. The input data node “assembly site” 512 represents one of a plurality of assembly sites, e.g., Site 1, Site 2, Site 3, Site 4, etc. The input data node “requirements” represents the user requirements in form of an object of type Requirement that has three attributes: a boolean attribute “traveling” indicating whether the user will use the PC during frequent traveling; a string attribute “usage” has five possible values Business, Gaming, Photo Editing, Video Editing, and Writing indicating the main usage of the PC; and a string attribute “color” indicating the desired color of the PC.

The decision nodes of the dependency graph 500 are indicated by normal rectangles. The decision nodes are four intermediate decision nodes 504, 506, 508, 510 and one resulting decision node 514.

The “Base configuration” decision node 504 represents the choice of a base model for the PC. For this example, suppose there are three possible model values: Entry, Standard, and Advanced. This decision depends on the requirements (shown by an arrow leading from the “requirements” node to the “Base configuration” node). The “graphic processor” decision node 508 represents the choice between a PC with a graphics processor and a PC without a graphics processor. The “graphic processor” decision node 508 depends on the requirements and the chosen base configuration. The “storage” decision node 506 represents the choice of the size of the storage. For this example, suppose there are three possible values: 256 GB, 512 GB, and 1 TB. The “storage” decision node 506 depends on the requirements and the chosen base configuration. The “processor” decision node 510 represents the choice of the main processor, which, for this example, is either a Core 4, Core 8, Core 16, or Core 32 processor. The “processor” decision node 510 choice depends on the base configuration, the presence of a graphic processor, and the storage. The “cooling system” decision node 514 represents the cooling system of the PC, which, for this example, is either a heat sink, a fan, or liquid cooling. The choice of the cooling system is the resulting decision for the considered scenario. It depends on the processor and the assembly site.

Tables 1-5 show the decision logics for the five different decision nodes:

TABLE 1
Base Configuration Node

| | | BASE |
|---|---|---|
| USAGE | TRAVELLING | CONFIGURATION |
| Business | Not Travelling | Standard |
| Business | Travelling | Entry |
| Gaming | Not Travelling | Advanced |
| Gaming | Travelling | Standard |
| Photo Editing | Not Travelling | Standard |
| Photo Editing | Travelling | Entry |
| Video Editing | N/A | Advanced |
| Writing | N/A | Entry |

TABLE 2
Storage Node

| | BASE | |
|---|---|---|
| USAGE | CONFIGURATION | STORAGE |
| Business | Entry | SSD 256 GB |
| Business | Standard | SSD 512 GB |
| Gaming | Standard | SSD 256 GB |
| Gaming | Advanced | SSD 512 GB |
| Photo Editing | Entry | SSD 256 GB |
| Photo Editing | Standard | SSD 512 GB |
| Photo Editing | Advanced | SSD 1 TB |
| Video Editing | N/A | SSD 1 TB |
| Writing | N/A | SSD 256 GB |

TABLE 3
Graphics Processor Node

| BASE | | GRAPHICS |
|---|---|---|
| CONFIGURATION | USAGE | PROCESSOR |
| Entry | N/A | No |
| Standard | Business | No |
| Standard | Gaming | Yes |
| Standard | Photo Editing | Yes |
| Standard | Video Editing | Yes |
| Standard | Writing | No |
| Advanced | N/A | Yes |

TABLE 4
Processor Node

| BASE | GRAPHICS | | |
|---|---|---|---|
| CONFIGURATION | PROCESSOR | STORAGE | PROCESSOR |
| Entry | No | SSD 256 GB | Core 4 |
| Entry | No | SSD 512 GB | Core 4 |
| Standard | No | SSD 256 GB | Core 4 |
| Standard | No | SSD 512 GB | Core 4 |
| Standard | No | SSD 1 TB | Core 4 |
| Standard | Yes | SSD 256 GB | Core 8 |
| Standard | Yes | SSD 512 GB | Core 8 |
| Standard | Yes | SSD 1 TB | Core 16 |
| Advanced | Yes | SSD 512 GB | Core 16 |
| Advanced | Yes | SSD 1 TB | Core 32 |

TABLE 5
Cooling System Node

| ASSEMBLY | | COOLING |
|---|---|---|
| SITE | PROCESSOR | SYSTEM |
| Site 1 | Core 4 | Heatsink |
| Site 1 | Core 8 | Fan |
| Site 1 | Core 16 | Liquid Cooling |
| Site 1 | Core 32 | Liquid Cooling |
| Site 2 | N/A | Fan |
| Site 3 | N/A | Heatsink |
| Site 4 | N/A | Liquid Cooling |

For this example, the decision logic for the cooling-system decision table has a condition column for each node that is a direct predecessor of the cooling-system decision node 514 in the graph 500. Hence there is a column for the assembly site and a column for the processor. Furthermore, The cooling-system decision table has a single action column that determines the cooling-system value. The cooling-system decision table has seven rows, each of which chooses the cooling-system in the action column whenever the assembly site and processor meet the range or value listed in the respective condition columns. For example, a heat sink is chosen if the assembly site is Site 1 and the processor is a Core 4 processor.

Tables 6 and 7 correspond to two examples of customer orders that lead to different resulting decisions:

TABLE 6
Order resulting in fan

| REQUIREMENTS | |
|---|---|
| Travelling | Yes |
| Usage | Gaming |
| Color | Grey |
| Assembly site | Site 1 |

TABLE 7
Order resulting in liquid cooling

| REQUIREMENTS | |
|---|---|
| Travelling | Yes |
| Usage | Video Editing |
| Color | Grey |
| Assembly site | Site 1 |

The order in Table 6 corresponds to an incoming order for assembly site “Site 1” that receives a fan as cooling system. However, suppose Site 1 has only liquid cooling remaining in stock, so the configured PC for Table 6 cannot be assembled. Also, suppose for this example that that the assembly site cannot be changed from Site 1. In this case, either the PC will be delayed, or the customer will need to modify the order such that liquid cooling will be selected. The order in Table 7 corresponds to a modified case that has revised requirements resulting in liquid cooling and remaining at Site 1. In some embodiments, the order in Table 7 is generated based on a contrastive explanation determined according to disclosed embodiments, for example by explanation module 410 of FIG. 4.

Tables 8 and 9 show intermediate decisions obtained for the two orders in Tables 6 and 7, respectively:

TABLE 8
Intermediate decisions resulting in fan

| | |
|---|---|
| Requirements Node | Traveling = true |
| | Usage = Gaming |
| | Color = Grey |
| Base Configuration | Standard |
| Graphics Processor | Yes |
| Storage | SSD 256 GB |
| Processor | Core 8 |
| Assembly Site | Site 1 |
| Cooling System | Fan |

TABLE 9
Intermediate decisions resulting in liquid cooling

| | |
|---|---|
| Requirements Node | Traveling = true |
| | Usage = Video Editing |
| | Color = Grey |
| Base Configuration | Advanced |
| Graphics Processor | Yes |
| Storage | SSD 1 TB |
| Processor | Core 32 |
| Assembly Site | Site 1 |
| Cooling System | Liquid Cooling |

Comparing Tables 8 and 9 reveal that the cooling system can be changed from a fan to liquid cooling by changing the processor from a Core 8 processor to a Core 32 processor. This change of the processor can be achieved by changing the storage from 256 GB to 1 TB. The change in storage can be achieved by changing the usage from Gaming to Video Editing. It is the last change that really matters in the end, but the intermediate changes may be exposed to users as well, permitting users to see how changes are “propagating” from the resulting decision to input data, thereby providing explainability for the hierarchical rule rule-based system.

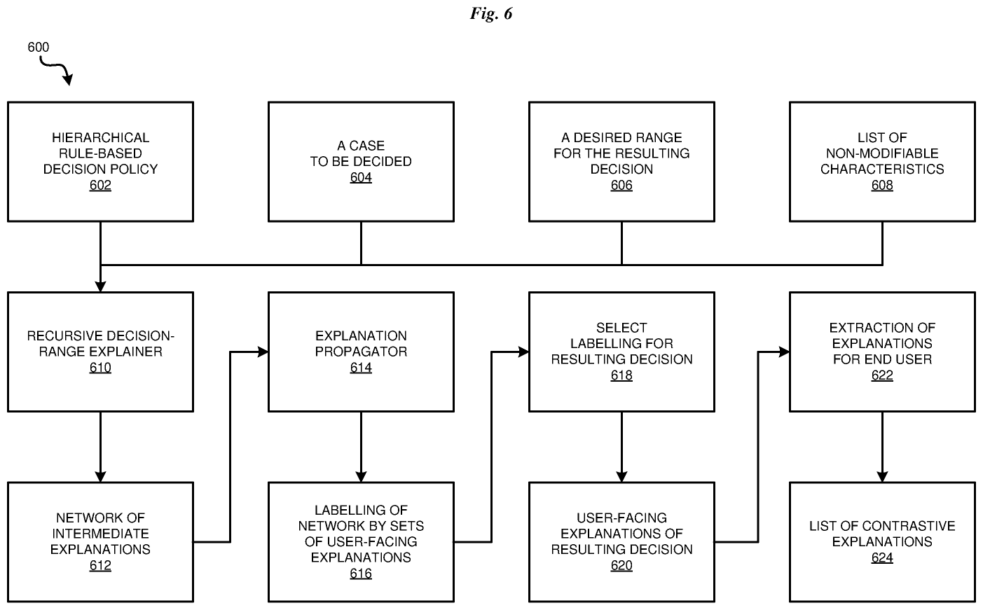

With reference to FIG. 6, this figure depicts a data flow block diagram of an example contrastive explanation system 600 in accordance with an illustrative embodiment. In a particular embodiment, the contrastive explanation system 600 is an example of explanation module 410 of FIG. 4.

In the illustrated embodiment, the contrastive explanation system 600 is provided with a hierarchical rule-based decision policy 602, a case to be decided 604, a desired range for the resulting decision 606, and a possibly empty list of non-modifiable case characteristics 608.

The hierarchical rule-based decision policy 602 is specified by a dependency graph that has input data nodes describing a case and decision nodes for all decisions made by the policy. In some embodiments, the dependency graph 500 is an example of a hierarchical rule-based decision policy 602. The value of a decision node (e.g., decision nodes 504, 506, 508, and 510) may depend on the values of other nodes, which are referred to as the information nodes of the decision node. The dependencies are represented by edges leading from the information nodes to their decision node. Each decision node has a rule-based decision logic that defines which decision will be made for which values of its information nodes. This decision logic may include condition-action rules and decision tables (e.g., Tables 1-5). The condition-action rules are represented by syntax trees according to a rule language. A decision table has condition columns for the information nodes and an action column for the decision node. A row of the decision table stipulates conditions on the information nodes and specifies a value that will be assigned to the decision node if those conditions are met.

The case to be decided 604 specifies values for the input data nodes. Tables 6 and 7 show examples of values for the input data nodes for cases to be decided 604.

The desired range of the resulting decision 606 is a set of one or more values representing a desired alternative outcome. The desired range of the resulting decision 606 can be specified by an enumeration of values or by an interval. An example of a desired range of a resulting decision 606 is the desired cooling system that is a liquid cooling system in the example above.

The list of non-modifiable case characteristics 608 contains input data nodes combined with a possibly empty sequence of attributes. An element of this list thus describes an entire input data node or some direct or indirect attribute of this node. The values of these nodes or attributes must not be changed when computing a contrastive explanation. An example of non-modifiable case characteristics 608 is the fixed assembly site in the example above.

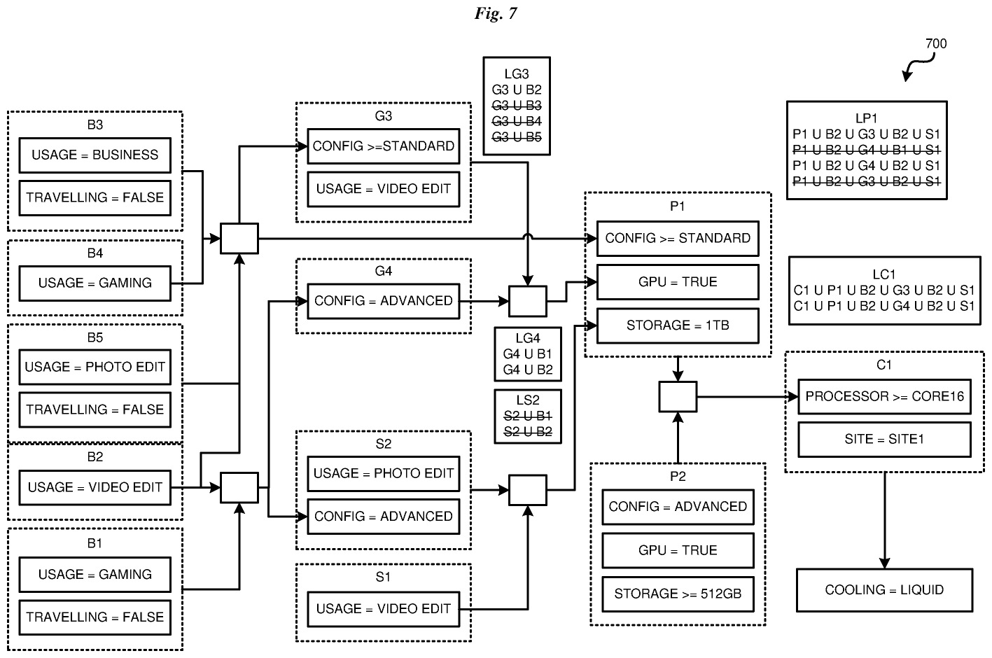

The contrastive explanation system 600 includes a recursive decision-range explainer 610 that is supplied with the hierarchical rule-based decision policy 602, the case to be decided 604, the desired range for the resulting decision 606, and the list of non-modifiable characteristics 608 (if any). The recursive decision-range explainer 610 recursively computes a network of intermediate explanations 612, such as the network of intermediate explanations 700 of FIG. 7. An explanation propagator 614 then aggregates the intermediate explanations into user-facing explanations for each intermediate explanation in the network. This includes labelling the network of intermediate explanations with the sets of user-facing explanations at block 616, selecting labels at block 618 that correlate with the desired range for the resulting decision 606, and transforming the selected labels into user-facing explanations of resulting decision at block 620, which are extracted at 622. Finally, the system transforms the user-facing explanations of the resulting decision into a report or other format for the end-user at block 624.

With reference to FIG. 7, this figure depicts an example network 700 of intermediate explanations in accordance with an illustrative embodiment. In a particular embodiment, the recursive decision-range explainer 610 of FIG. 6 recursively computes the network 700 of intermediate explanations. The view shown in FIG. 7 depicts only a portion of a complete network of intermediate explanations for the sake of brevity and clarity.

The network 700 includes examples of labels LC1, LP1, LS2, LG4, and LG3 generated by the explanation propagator 614 of FIG. 6 for C1, P1, S2, G4, and G3, respectively. For example, label LC1 lists combinations of conditions with those of C1 that result in the desired range for the resulting decision 606 (i.e., liquid cooling).

For the desired liquid cooling, the cooling-system decision has a user-facing explanation with the range constraints shown in Table 10:

TABLE 10

| Requirements | |
|---|---|
| Usage | Video Editing |
| Assembly site | Site 1 |
| Base Configuration | >=Standard |
| Graphics Processor | Yes |
| Storage | SSD 1 TB |
| Processor | >=Core 16 |

The first range constraint refers to the attribute “usage” of the input data node “requirements.” The second range constraint refers to the input data node “assembly site.” The other range constraints refer to intermediate decision nodes. If some case satisfies the range constraints on the input data nodes, then the rules will make decisions that satisfy the range constraints for the intermediate decision nodes. Furthermore, the user-facing explanation also guarantees that the resulting decision for such a case will fall into the desired range, i.e., a cooling-system that is liquid cooling.

Hence, a liquid cooling system can be obtained by changing the usage to video editing and by keeping the assembly site of Site 1. Other characteristics of the given case need not be changed. Depending on the user profile, it may thus be sufficient to just communicate the range constraints on input data that are violated by the given case. This leads to a reduced form of the explanation: A liquid cooling system can be obtained by changing the usage to video editing.

It is also possible to complete the user-facing explanation by information from the given case. For example, the case shown in Table 9 is obtained by setting the usage to video editing as required by the user-facing explanation and by keeping the values from the original case (shown on the left side of the figure) for the other characteristics of the case.

In some embodiments, some users, such as business analysts, may also be interested in the part of the user-facing explanation that concerns the intermediate decisions and having them displayed in the dependency graph. For example, the user may be provided with information showing that the change to video editing results in change of storage to 1 TB, which results in processor change to Core 32, which results in cooling system change to liquid cooling. This information allows the user to see how changes propagate from the resulting decision to the input data.

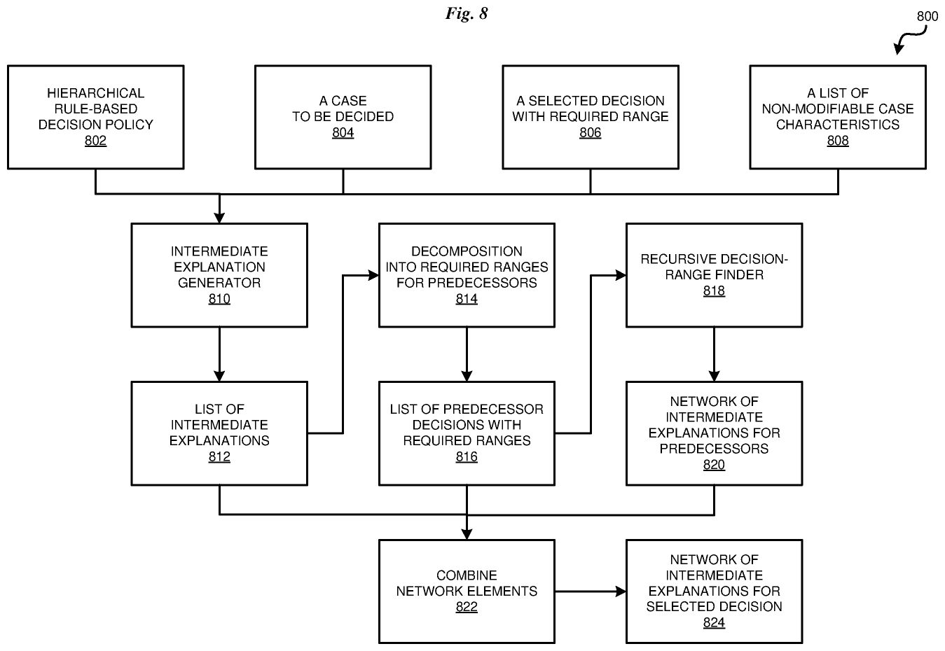

With reference to FIG. 8, this figure depicts a data flow block diagram of an example recursive decision-range explainer 800 in accordance with an illustrative embodiment. In a particular embodiment, the recursive decision-range explainer 800 is an example of recursive decision-range explainer 610 of FIG. 6.

In the illustrated embodiment, the recursive decision-range explainer 800 is supplied with the hierarchical decision policy 802, the given case 804 to be decided, a selected decision node 806 including a required range for the selected decision node, and a list of non-modifiable case characteristics (if any) 808.

A system for computing contrastive explanations (e.g., contrastive explanation system 600 of FIG. 6) invokes the recursive decision-range explainer 800 for the desired resulting decision 808 and the given desired range for it. Recursive calls will concern intermediate decision nodes as well as ranges for these nodes required by already computed intermediate explanations. Therefore, the recursive decision-range explainer 800 is provided with a selected decision node that is not necessarily the resulting decision node. Moreover, the recursive decision-range explainer 800 is invoked with a required range for the selected decision node that is not necessarily the given desired range.

The recursive decision-range explainer 800 includes an intermediate explanation generator 810 that computes one or more intermediate explanations at block 812 for the required range of the selected decision node. Such an intermediate explanation is a conjunction of range constraints formulated over the information nodes of the selected decision node. If the values of these information nodes satisfy these range constraints, the decision logic will make a decision that falls into the required range. It should be noted that an intermediate explanation ensures that non-modifiable characteristics of the given case are keeping their value from the case.

According to Tables 1-5, liquid cooling will be chosen if the processor is at least a Core 16 processor and the assembly site is Site 1. Such a cooling-system will also be given if the assembly site is Site 4. However, as the assembly site must not be changed, in the present example, the system will compute only the following intermediate explanation, which is also shown as C1 of FIG. 7:

C1: processor>=Core 16 and assembly site=Site 1

The recursive decision-range explainer 800 will decompose such an intermediate explanation into a list of range constraints at block 814, namely one for each decision node. The intermediate explanation C1 has two range constraints. The first one refers to the processor node, which is an intermediate decision, and the second one refers to the assembly site, which is an input data node. Range constraints on input data nodes cannot be further refined and are thus ignored by the decomposition step. Therefore, only a single range constraint is obtained by decomposing C1: “processor>=Core 16.”

The recursive decision-range explainer 800 makes a recursive call to itself at block 818 for each range constraint of a predecessor decision node, resulting in a network of intermediate explanations for predecessors at block 820 and it has a single sink node which is the selected range constraint.

In the present example, the first recursive call will thus concern the processor decision and the required range of a Core 16 processor or better. The decision table for the processor decision shown as Table 4 above has three rows leading to a Core 16 processor or a better processor, i.e., a Core 32 processor. A naïve approach would involve computing a dedicated intermediate explanation for each of these processors. An advantage of the present embodiments is that the recursive decision-range explainer 800 computes intermediate explanations for a whole range of processor values, thus allowing a regrouping of multiple pointwise explanations. Moreover, the recursive decision-range explainer 800 computes intermediate explanations that have a most-general form, allowing even more regrouping of explanations. This regrouping will lead to more compact explanation networks. In the example, it is sufficient to cover all possibilities for obtaining a Core 16 processor or better by two intermediate explanations:

P1: base configuration>=Standard and graphic processor=true and storage=1 TB

P2: base configuration=Advanced and graphic processor=true and storage>=512 GB

Compared to the given case, the explanation P1 requires one change (the storage), whereas the second explanation P2 requires two changes (base configuration and storage).

For the sake of brevity, the following text only details the processing of P1. The intermediate explanation P1 will be decomposed in three range constraints concerning the decision nodes “base configuration,” “graphic processor,” and “storage.” The required range for the decision node “storage” just contains the value “1 TB” and thus requires a change of the original value of “256 GB.” The required range for the decision node “graphic processor” has the original value “true.” Nevertheless, it will be necessary to compute explanations for this non-modified decision as well in order to guarantee that this original value is preserved when computing user-facing explanations. Finally, the required range for the decision node “base configuration” includes the values Standard and Advanced. This range contains the original value Standard, but permits a change to Advanced if necessary for other reasons.

The recursive decision-range finder 818 calls itself for each of these required ranges. For the required storage of 1 TB, two intermediate explanations are found:

S1: requirements.usage=Video Editing

S2: requirements.usage=Photo Editing and base configuration=Advanced

The intermediate explanation S1 only includes a single range constraint and it concerns the input data node “requirements.” This range constraint does not require any further refinement and the recursive decision-range explainer 800 will not carry out a recursive call for it.

The intermediate explanation S2 requires the value Advanced for the base configuration, which is a decision node. The recursive decision-range explainer 800 will therefore conduct a recursive call for it. There are two intermediate explanations for obtaining an advanced base configuration:

B1: requirements.usage=Gaming and requirements.traveling=false

B2: requirements.usage=Video Editing

These intermediate explanations only concern input data nodes, meaning that the recursive decision-range explainer 800 will not issue any recursive call when explaining the advanced base configuration. The recursive decision-range explainer 800 will combine the network elements, i.e., connect the B1 and B2 with the range constraint “base configuration=Advanced” at block 822. The recursive decision-range explainer 800 will return the resulting network at block 824 showing these three nodes and their two edges.

The recursive decision-range explainer 800 can now continue the processing for the required storage of 1 TB. It connects the range constraint “base configuration=Advanced” with the intermediate explanation S2. Furthermore, it connects S1 and S2 with the range constraint “storage=1 TB” and returns the resulting network.

As explained above, the intermediate explanation P1 leads to two further recursive calls, namely one for the range constraint “base configuration>=Standard” and the other one for “graphic processor=true.” A base configuration of Standard or Advanced is obtained in the following situations:

B2: requirements.usage=Video Editing

B3: requirements.usage=Business and requirements.traveling=false

B4: requirements.usage=Gaming

B5: requirements.usage=Photo Editing and requirements.traveling=false

These intermediate explanations concern only input data nodes and do not require any further recursive calls. It should also be noted that the intermediate explanation B2 has already been generated before. Therefore, it is not necessary to generate a new node for it, but it will be assumed that the existing node is retrieved in an adequate way. Methods for caching and retrieving data structures are well-known in the art and will not be detailed here for the sake of brevity. The recursive decision-range explainer 800 will connect the intermediate explanations B2, B3, B4, and B5 with the range constraint “base configuration>=Standard” and return the resulting network.

The recursive call for the range constraint “graphic processor=true” generates the following intermediate explanations:

G1: base configuration>=Standard and usage=Gaming

G2: base configuration>=Standard and usage=Photo Editing

G3: base configuration>=Standard and usage=Video Editing

G4: base configuration=Advanced

These intermediate explanations contain the range constraints “base configuration>=Standard” and “base configuration=Advanced.” Explanation networks for these range constraints have already been computed in other recursive calls and it is not necessary to compute them again. It will therefore be assumed that the existing nodes for these range constraints will be retrieved.

The recursive decision-range explainer 800 will connect the range constraint “base configuration>=Standard” with G1, G2, and G3 and the range constraint “base configuration=Advanced” with G4. Furthermore, it connects G1, G2, G3, and G4 with the range constraint “graphic processor=true” and it returns the resulting network. G1 and G2, which are not shown in FIG. 7, are similar to G3 but require usage=gaming and usage=photo editing, respectively, in place of usage=video editing.

Once the recursive decision-range explainer 800 has computed networks of explanations for the three range constraints “base configuration>=Standard,” “graphic processor=true,” and “storage=1 TB” occurring in P1. It connects these range constraints with P1. Furthermore, it will compute networks of explanations for the three range constraints “base configuration=Advanced,” “graphic processor=true,” and “storage>=512 GB” for P2 and connects them with P2. As these computations are similar to those already explained, they will not be further detailed and are not shown for the sake of brevity. In a final step, the recursive decision-range explainer 800 will connect P1 and P2 with the range constraint “processor>=Core 16” and return the result.

The recursive decision-range explainer 800 then returns to the initial call and connects the range constraint “processor>=Core 16” with C1 and the latter with the range constraint “cooling-system=liquid-cooling.” It returns the result and has thus finished its computation.

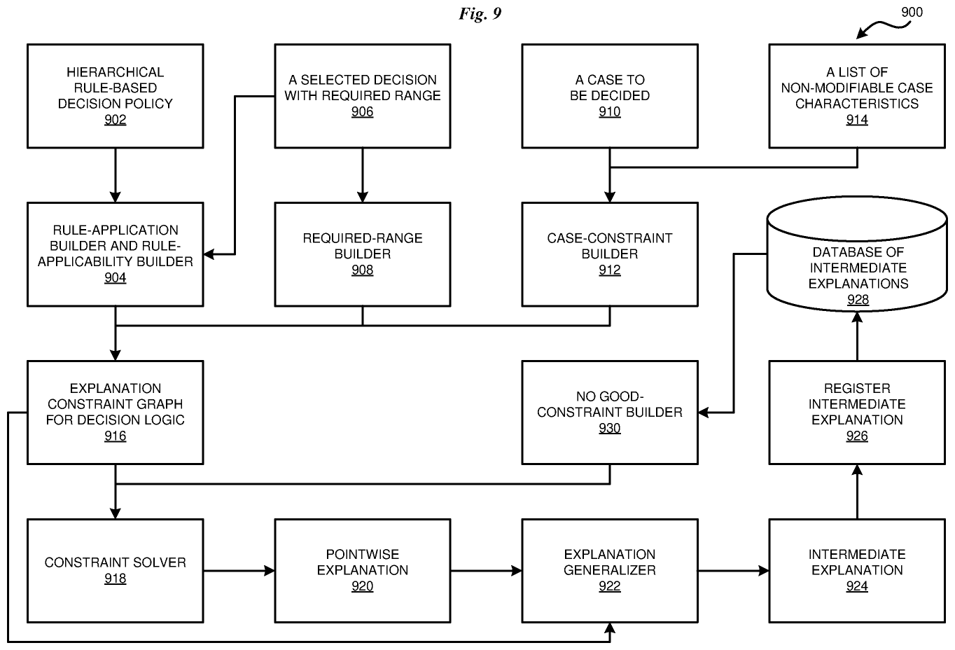

With reference to FIG. 9, this figure depicts a data flow block diagram of an intermediate explanation generator 900 in accordance with an illustrative embodiment. In a particular embodiment, the intermediate explanation generator 900 is an example of intermediate explanation generator 810 of FIG. 8.

In the illustrated embodiment, the intermediate explanation generator 900 is supplied with the hierarchical decision policy 902, a selected decision node 904 including a required range for the selected decision node, the given case 906 to be decided, and a list of non-modifiable case characteristics (if any) 914.

An intermediate explanation is a conjunction of range constraints formulated over the information nodes of a selected decision node such that the rules are making a required decision whenever the range constraints are satisfied. Furthermore, the intermediate explanation needs to ensure that non-modifiable characteristics of the given case are keeping their values from the given case. For example, the following conjunction is an intermediate explanation for obtaining a Core 16 processor or a better processor:

P2: base configuration=Advanced and graphic processor=true and storage>=512 GB

There are two possibilities of assigning values to the information nodes “base configuration,” “graphic processor,” and “storage” such that these range constraints are satisfied. The first of these value combinations is:

base configuration: Advanced

graphic processor: true

storage: 512 GB

The second of these value combinations is:

base configuration: Advanced

graphic processor: true

storage: 1 TB

Each of these value combinations ensures that the rules are making a required decision. Such a value combination can thus be considered a pointwise explanation as it corresponds to a point in the space of all value combinations. An intermediate explanation will then include a family of those pointwise explanations.

The intermediate explanation generator 900 will first find a pointwise explanation at block 920 and then generalize it at block 922 into an intermediate explanation 924. It uses constraint satisfaction techniques for this purpose.

A rule-application builder of a rule-application/rule-applicability builder module 904 creates a rule-application constraint graph that is describing the behavior of the decision logic of the selected decision node. An assignment of values to the information nodes and the decision node satisfies this constraint graph if either no rule is applicable under the values of the information nodes or a rule is applicable and makes the decision that corresponds to the value of the decision node. The constraint graph has nodes for variables, values, and operations such as equality, conjunction, and implication.

For the example scenario, the constraint graph may include the following:
base configuration=Entry and graphic processor=false and storage=256 GB implies processor=Core 4
base configuration=Entry and graphic processor=false and storage=512 GB implies processor=Core 4
base configuration=Standard and graphic processor=false and storage=256 GB implies processor=Core 4
base configuration=Standard and graphic processor=false and storage=512 GB implies processor=Core 4
base configuration=Standard and graphic processor=false and storage=1 TB implies processor=Core 4
base configuration=Standard and graphic processor=true and storage=256 GB implies processor=Core 8
base configuration=Standard and graphic processor=true and storage=512 GB implies processor=Core 8
base configuration=Standard and graphic processor=true and storage=1 TB implies processor=Core 16
base configuration=Advanced and graphic processor=true and storage=512 GB implies processor=Core 16
base configuration=Advanced and graphic processor=true and storage=1 TB implies processor=Core 32

A pointwise explanation requires that some rule is applied and makes a decision. A rule-applicability builder of the rule-application/rule-applicability builder module 904 creates a rule-applicability constraint graph that requires that the condition of some of the rules is true. It corresponds to a disjunction of the rule condition. For the example scenario, this constraint graph may include the following:

(base configuration=Entry and graphic processor=false and storage=256 GB) or

(base configuration=Entry and graphic processor=false and storage=512 GB) or

(base configuration=Standard and graphic processor=false and storage=256 GB) or

(base configuration=Standard and graphic processor=false and storage=512 GB) or

(base configuration=Standard and graphic processor=false and storage=1 TB) or

(base configuration=Standard and graphic processor=true and storage=256 GB) or

(base configuration=Standard and graphic processor=true and storage=512 GB) or

(base configuration=Standard and graphic processor=true and storage=1 TB) or

(base configuration=Advanced and graphic processor=true and storage=512 GB) or

(base configuration=Advanced and graphic processor=true and storage=1 TB)

A pointwise explanation further requires that the decision falls into the required range. A required-range builder 908 constructs a decision-range constraint graph for the decision node that is satisfied if the decision has a required value. In the example, this is simply a range constraint ensuring that the processor is a Core 16 processor or better:

processor>=Core 16

Finally, a pointwise explanation imposes that the non-modifiable case characteristics are not changed. In the given example, none of the information nodes concern non-modifiable case characteristics as “base configuration,” “graphic processor,” and “storage” are all intermediate decision nodes. In another example, a case-constraint builder 912 will add a constraint fixing the non-modifiable input data node “assembly site” to its given value “Site 1.” This constraint is added when computing an intermediate explanation for the desired cooling-system.

Returning back to the explanation for the required Core 16 processor or better, the three different constraint graphs are combined into a single constraint graph which represents the conjunction of the three constraint graphs at block 916. The result is the explanation constraint-graph for the required Core 16 processor or better. A constraint solver 918 determines a solution of this constraint graph, i.e., an assignment of values to the graph nodes that satisfies their semantics.

It may happen that no solution exists as no rule will make a decision in the required range. In this case, the constraint solver does not find a pointwise explanation, meaning that the intermediate explanation generator 900 will not find any intermediate explanation. The generation therefore stops in that case and an empty list of intermediate explanations will be returned.

In the given example, the constraint solver finds a solution and it assigns the following values to the information nodes and the selected decision node:

base configuration: Advanced

graphic processor: true

storage: 512 GB

processor: Core 16

This solution corresponds to a pointwise explanation which is obtained by dropping the value assignment to the selected decision node “processor”:

base configuration: Advanced

graphic processor: true

storage: 512 GB

The intermediate explanation generator 900 will next generalize this pointwise explanation into an intermediate explanation. The pointwise explanation can be described in terms of constraints that assign values to the information nodes:

base configuration=Advanced,

graphic processor=true,

storage=512 GB

The purpose of the generalization involves replacing certain of these constraints by range constraints such that the rules are still making the required decision. For example, the constraint “storage=512 GB” may be replaced by the range constraint “storage>=512 GB”, thus leading to the following set of constraints:

base configuration=Advanced,

graphic processor=true,

storage>=512 GB

Any assignment of values to the information nodes that satisfies these constraints will still guarantee that some of the rules is applicable and makes a required decision. In other words, there is no solution of the rule-application constraint graph that satisfies these constraints while violating the rule-applicability constraint graph or the decision-range constraint graph. In order to test this, an explanation generalizer 922 will construct a non-explanation constraint graph that is the conjunction of the rule-application constraint graph and the disjunction of the negation of the rule-applicability constraint graph and the negation of decision-range constraint graph.

A constraint solver 918 can then check whether a set of range constraints is an intermediate explanation. For this purpose, it searches a solution that satisfies both the non-explanation constraint graph and the set of range constraints. If such a solution exists, the set of range constraints includes a possibility where either no rule is applicable (i.e., the solution satisfies the negation of the rule-applicability constraint graph) or this rule makes a decision that is not a required one (i.e., the solution satisfies the negation of the decision-range constraint graph).

For example, the following set of range constraints allows the possibility that the storage is 256 GB. As no rule is applicable for this storage size and the advanced configuration with graphic processor, there will be a solution that satisfies the non-explanation constraint graph and this set of range constraints. Therefore, this set of range constraints does not constitute an intermediate explanation.

base configuration=Advanced,

graphic processor=true,

storage>=256 GB

In order to use this checking method, the explanation generalizer 922 first has to generate candidate range constraints for each information node. If an information node has a finite domain, it may generate one or two range constraints for each value in the domain. It needs to be ensured that this domain constraint is satisfied by the pointwise explanation. For example, the base configuration has the value Advanced in the pointwise explanation. Therefore, the following range constraints are generated for the base configuration:

base configuration>=Entry

base configuration>=Standard

base configuration=Advanced

The information node “graphic processor” has the value “true” in the pointwise explanation. It does not make sense to add a range constraint requiring that the graphic processor be at least false since such a range constraint is necessarily true. It can thus be omitted, meaning that only the following range constraint is kept:

graphic processor=true

The information node “storage” has the value of 512 GB in the pointwise explanation. The explanation generalizer 922 may add four range constraints.

storage>=256 GB

storage>=512 GB

storage<=512 GB

storage<=1 TB

The range constraints “storage<=256 GB” and “storage>=1 TB” are not considered since they exclude the value of 512 GB that is found in the pointwise explanation. Furthermore, the range constraints “storage>=256 GB” and “storage<=1 TB” are necessarily true and can be discarded as well.

For infinite domains, the generation of range constraints has to be limited to a finite subset of the domain. It is recommended to cover all domains values occurring in some rule condition. It may also be possible to choose a set of values that are exponentially growing and refine this set in further iterations.

Given a set of candidate range, the next step includes finding a subset that is an intermediate explanation. As explain above, it can be checked whether a subset of range constraints is an intermediate explanation. If a constraint solver does not find any solution of the non-explanation constraint graph and the candidate subset, then the subset of range constraints satisfies all requirements of an intermediate explanation and succeeds the check. However, if the constraint solver finds a solution, then some requirement is violated, and the subset is not an intermediate explanation.

A naïve method would simply explore all candidate subsets and perform this check. This would require an exponential number of constraint solver calls, which is prohibitive. It is indeed possible to find an intermediate explanation with much less constraint solver calls. For this purpose, all generated range constraints are supplied together to a minimal conflict detector. In the given example, this list includes the following range constraints:

base configuration>=Entry

base configuration>=Standard

base configuration=Advanced

graphic processor=true

storage>=512 GB

storage<=512 GB

The minimal conflict detector will find a minimal subset of the range constraints such that no solution of the non-explanation constraint graph satisfies all range constraints in the subset. This problem is also known as the extraction of minimal unsatisfiable subsets (MUS extraction) and there are efficient algorithms for this problem known in the art.

For example, a minimal conflict detector may return the following set of range constraints for the considered example. This set of range constraints constitutes an intermediate explanation:

base configuration=Advanced

graphic processor=true

storage>=512 GB

The minimal conflict detector may return intermediate explanations that are not most general ones. In order to avoid this, the range constraints are ordered by decreasing generality. The minimal conflict detector will then remove less general range constraints first.

The intermediate explanation generator 900 will register the intermediate explanation in a database of intermediate explanations at block 926, which will be returned in the end. As there may be further intermediate explanations, the system will repeat the steps explained above while ensuring that already computed intermediate explanations will not be computed again. For this purpose, a no-good-constraint builder 930 will build a no-good constraint graph and pass it to the constraint solver. The no-good constraint graph is a conjunction of the negations of all intermediate explanations in the database of intermediate explanations 928.

In the current example, the database contains one intermediate explanation. The no-good constraint graph simply is the negation of this explanation, for example:

not (base configuration=Advanced and graphic processor=true and storage>=512 GB) The constraint solver now has to find a solution that satisfies the explanation constraint graph as well as the no-good constraint graph. It is able to find such a solution, for example:

base configuration: Standard

graphic processor: true

storage: 1 TB

processor: Core 16

This solution corresponds to the following pointwise explanation:

base configuration: Standard

graphic processor: true

storage: 1 TB

The explanation generalizer 922 will produce the following intermediate explanation (note that the explanation generalizer 922 does not take the no-good constraint graph into account, meaning that the newly intermediate explanation may include some pointwise explanation that is already covered by other intermediate explanations):

base configuration>=Standard

graphic processor=true

storage=1 TB

This new intermediate explanation will be registered into the database of intermediate explanations and a new no-good-constraint graph will be created in turn. Its textual form is as follows:
not (base configuration=Advanced and graphic processor=true and storage>=512 GB) and not (base configuration>=Standard and graphic processor=true and storage=1 TB)

The constraint solver will not be able to find a solution that satisfies both this no-good-constraint graph and the explanation-constraint graph. Therefore, the system has found all intermediate explanations for a Core 16 processor or a better processor and returns all intermediate explanations that have been registered in the database.

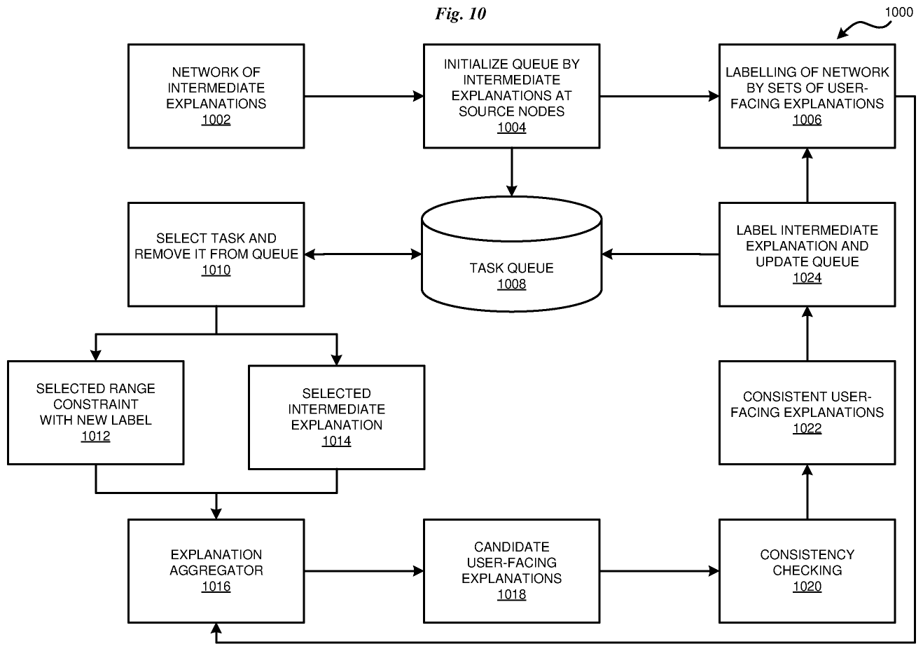

With reference to FIG. 10, this figure depicts a data flow block diagram of an explanation propagator 1002 in accordance with an illustrative embodiment. In a particular embodiment, the explanation propagator 1002 is an example of explanation propagator 614 of FIG. 6.

In the illustrated embodiment, the explanation propagator 1002 is supplied with the network of intermediate explanations 1002. In some embodiments, the explanation propagator 1002 aggregates the intermediate explanations 1002 into explanations for the desired range of the resulting decision such that the aggregated explanations are essentially formulated over input data, but not over intermediate decisions.

The explanation propagator 1002 will label each intermediate explanation in the given network by a set of user-facing explanations at block 1006. In an initial step, it will inspect all source nodes of the network at block 1004. The source nodes are intermediate explanations that refer only to input data nodes and no decision node. These explanations have already the form of user-facing explanations. The explanation propagator 1002 will label those explanations with themselves. Hence, the label of an intermediate explanation that is a source node in the given network will be a singleton that contains this intermediate explanation itself.

The explanation propagator 1002 will then use a task queue 1008 to propagate new elements in a label over the network. The queue will contain descriptions of how to update successor nodes. Each time a user-facing explanation is added to the label of a first intermediate explanation, a task will be created for each range constraint that is a direct successor of this intermediate explanation and for each second intermediate explanation that is a direct successor of this range constraint. This task contains the following information:
(a) The range constraint.
(b) The user-facing explanation that has been added to the label of the first intermediate explanation.
(c) The second intermediate explanation which needs to be updated.
   In particular, the explanation propagator 1002 will update the task queue 1008 at block 1024 when setting the labels for the source nodes.

The explanation propagator 1002 then processes one task in the queue after the other until the task queue 1008 is empty. Embodiments of the explanation propagator 1002 process the tasks by first selecting a task from the queue and removing it from the queue at block 1010. As explained above, the task specifies a selected range constraint at block 1012 and selected intermediate explanation at block 1014, use an explanation aggregator 1016 to generate user-facing explanations at block 1018, check the explanations for conflicts or inconsistencies that would make them impossible to realize at block 1020, retain those user-facing explanations at block 1022 that have consistent explanations without conflicts, add the consistent user-facing explanation to the label of some predecessors of this range constraint at block 1024 and store the updated information in the task queue 1008.

This update process that spans blocks 1010-1024 will now be explained with reference to the intermediate explanation G3 in FIG. 7. The update task concerns the range constraint “base configuration>=Standard” and the new label element B2 at block 1012. An explanation aggregator 1016 will retrieve the labels for the other range constraints that are direct predecessors of G3. As the range constraint “base configuration>=Standard” is the only direct predecessor of G3, this step will return an empty list. The explanation aggregator 1016 therefore combines only the new label element B2 with G3 by set union. Whereas the intermediate explanations such as B2 and G3 have been defined as conjunctions of range constraints before, the explanation propagator 1002 will process them as if they are sets of range constraints. Hence, the user-facing explanation obtained by the union of B2 and G3 contains the following range constraints:

requirements.usage=Video Editing

base configuration>=Standard

Next, the consistency of this user-facing explanation is checked with the help of a constraint solver. In this example, the explanation is consistent. It is therefore added to the label of G3 and a task for updating the label of P2 is created. This update task also specifies the range constraint “graphic processor=true” and the new label element G3 U B2.

Another update step for G3 may concern the range constraint “base configuration>=Standard” and the new label element B3. The explanation aggregator 1016 will combine B3 with G3 and the resulting explanation contains the following range constraints:

requirements.usage=Video Editing

requirements.usage=Business

base configuration>=Standard

This explanation is not consistent as the usage attribute can have only a single value. The consistency checker will therefore reject this explanation. It will not be added to the label of G3.

Other intermediate explanations may receive multiple label elements. An example is G4 which has the two label elements G4 U B1 and G4 U B2 as shown in FIG. 7. Both are consistent as all their range constraints concern different variables and attributes. There are also intermediate explanations with an empty label. An example is S2. The two candidate explanations S2 U B1 and S2 U B2 are both inconsistent as S2 imposes photo editing whereas B1 and B2 are imposing gaming or video editing.

The label computations for G3, G4, and S2 have been simple since these nodes have a single predecessor. It will now be supposed that the labels of these intermediate explanations have been determined as described above and that the explanation propagator 1002 processes an update task for P1, the range constraint “storage=1 TB” and a new label element S1.

As explained above, the explanation aggregator 1016 has to retrieve the labels for all other range constraints that are predecessors of the selected intermediate explanation. P1 has two further range constraints, namely “base configuration>=Standard” and “graphic processor=true.” The label of a range constraint is the union of the labels of all its direct predecessors. In the given state of computation, the range constraint “base configuration>=Standard” has the four label elements, namely B2, B3, B4, and B5. The range constraint “graphic processor=true” has three label elements, namely G3 U B2, G4 U B 1, and G4 U B2. The explanation aggregator 1016 will determine the Cartesian product of these two labels and add the new label element S1 as well as the selected intermediate explanation P1 to each of these combinations, resulting as follows:

P1, B2, G3 ∪B2, S1

P1, B2, G4 ∪B1, S1

P1, B2, G4 ∪B2, S1

P1, B3, G3 ∪B2, S1

P1, B3, G4 ∪B1, S1

P1, B3, G4 ∪B2, S1

P1, B4 G3 ∪B2, S1

P1, B4, G4 ∪B1, S1

P1, B4, G4 ∪B2, S1

P1, B5, G3 ∪B2, S1

P1, B5, G4 ∪B1, S1

P1, B5, G4 ∪B2, S1

The explanation aggregator 1016 will then determine the union of elements for each of these combination in order to create candidates for user-facing explanations:

P1 ∪B2 ∪G3 ∪B2 ∪S1

P1 ∪B2 ∪G4 ∪B1 ∪S1

P1 ∪B2 ∪G4 ∪B2 ∪S1

P1 ∪B3 ∪G3 ∪B2 ∪S1

P1 ∪B3 ∪G4 ∪B1 ∪S1

P1 ∪B3 ∪G4 ∪B2 ∪S1

P1 ∪B4 ∪G3 ∪B2 ∪S1

P1 ∪B4 ∪G4 ∪B1 ∪S1

P1 ∪B4 ∪G4 ∪B2 ∪S1

P1 ∪B5 ∪G3 ∪B2 ∪S1

P1 ∪B5 ∪G4 ∪B1 ∪S1

P1 ∪B5 ∪G4 ∪B2 ∪S1

Most of those candidates are inconsistent since they impose different usages of the PC. The consistency checker will only keep the following two:

P1 ∪B2 ∪G3 ∪B2 ∪S1

P1 ∪B2 ∪G4 ∪B2 ∪S1

These user-facing explanation are then propagated to C1. As C1 has a single direct predecessor and its range constraints concern other nodes than those in the two user-facing explanations, its label will be updated by the two elements:

C1 ∪P1 ∪B2 ∪G3 ∪B2 ∪S1

C1 ∪P1 ∪B2 ∪G4 ∪B2 ∪S1

Whereas the first of these user-facing explanations specifies that the base configuration needs to be at least Standard, the second one imposes that it is an advanced configuration. As both explanations have the same range constraints on input data, this difference is irrelevant for most users. Hence, only one of them should be reported to the end-user. The first of the explanations has the range constraints shown in Table 9 above. The important elements are the range constraints concerning the input data nodes:

requirements.usage=Video Editing

assembly site=Site 1

The explanation does not impose any constraint on traveling and on the color, meaning that liquid cooling will be obtained whatever the traveling option is false or true and whatever color is chosen. This includes also the values of the given case where traveling is true and the color is grey. This means that this explanation does not require a change of these attributes.

The explanation propagator 1002 will also compute labels for the intermediate explanations G1, G2, and P2. These computations follow the same principles as explained above. Once the explanation propagator 1002 has processed all tasks, it returns the labeled network.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer implemented method comprising:
receiving an explanation request that includes an undesired output resulting from an input case of a hierarchical rule-based decision policy specified by an acyclic dependency graph, and further includes an alternative desired output from the hierarchical rule-based decision policy;
computing a network of intermediate explanations for required ranges of respective decision nodes that achieve the desired output from the hierarchical rule-based decision policy;
computing a user-facing explanation that includes a range constraint for achieving the desired output by aggregating the intermediate explanations; and
transmitting, as a response to the explanation request, an explanation for achieving the desired output from the hierarchical rule-based decision policy based on the user-facing explanation.

2. The method of claim 1, wherein the dependency graph comprises input data nodes describing the input case and a plurality of decision nodes describing respective rules of the hierarchical rule-based policy.

3. The method of claim 1, wherein the network of intermediate explanations comprises an intermediate explanation for a first decision node that is a conjunction of range constraints for the first decision node and range constraints for a second decision node that directly precedes the first decision node.

4. The method of claim 1, wherein computing of the network of intermediate explanations comprises computing a first intermediate explanation for an output node of the acyclic dependency graph and generating refined intermediate explanations of the first intermediate explanation for respective intermediate decision nodes from the output node to an input node of the acyclic dependency graph.

5. The method of claim 1, wherein the aggregating of the intermediate explanations comprises taking a Cartesian product of the intermediate explanations.

6. The method of claim 1, wherein the aggregating of the intermediate explanations comprises ensuring that non-modifiable characteristics of the input case keep their values from the input case.

7. The method of claim 1, wherein the decision nodes represent intermediate and final results of the hierarchical rule-based decision policy.

8. A computer program product, the computer program product comprising one or more computer readable storage media, and program instructions collectively stored on the one or more computer readable storage media, the program instructions executable by one or more processors to cause the one or more processors to perform operations comprising:
receiving an explanation request that includes an undesired output resulting from an input case of a hierarchical rule-based decision policy specified by an acyclic dependency graph, and further includes an alternative desired output from the hierarchical rule-based decision policy;
computing a network of intermediate explanations for required ranges of respective decision nodes that achieve the desired output from the hierarchical rule-based decision policy;
computing a user-facing explanation that includes a range constraint for achieving the desired output by aggregating the intermediate explanations; and
transmitting, as a response to the explanation request, an explanation for achieving the desired output from the hierarchical rule-based decision policy based on the user-facing explanation.

9. The computer program product of claim 8, wherein the stored program instructions are stored in a computer readable storage device in a data processing system, and wherein the stored program instructions are transferred over a network from a remote data processing system.

10. The computer program product of claim 8, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

11. The computer program product of claim 8, wherein the dependency graph comprises input data nodes describing the input case and a plurality of decision nodes describing respective rules of the hierarchical rule-based policy.

12. The computer program product of claim 8, wherein the network of intermediate explanations comprises an intermediate explanation for a first decision node that is a conjunction of range constraints for the first decision node and range constraints for a second decision node that directly precedes the first decision node.

13. The computer program product of claim 8, wherein computing of the network of intermediate explanations comprises computing a first intermediate explanation for an output node of the acyclic dependency graph and generating refined intermediate explanations of the first intermediate explanation for respective intermediate decision nodes from the output node to an input node of the acyclic dependency graph.

14. The computer program product of claim 8, wherein the aggregating of the intermediate explanations comprises taking a Cartesian product of the intermediate explanations.

15. The computer program product of claim 8, wherein the aggregating of the intermediate explanations comprises ensuring that non-modifiable characteristics of the input case keep their values from the input case.

16. The computer program product of claim 8, wherein the decision nodes represent intermediate and final results of the hierarchical rule-based decision policy.

17. A computer system comprising one or more processors and one or more computer readable storage media, and program instructions collectively stored on the one or more computer readable storage media, the program instructions executable by the one or more processors to cause the one or more processors to perform operations comprising:
receiving an explanation request that includes an undesired output resulting from an input case of a hierarchical rule-based decision policy specified by an acyclic dependency graph, and further includes an alternative desired output from the hierarchical rule-based decision policy;
computing a network of intermediate explanations for required ranges of respective decision nodes that achieve the desired output from the hierarchical rule-based decision policy;
computing a user-facing explanation that includes a range constraint for achieving the desired output by aggregating the intermediate explanations; and
transmitting, as a response to the explanation request, an explanation for achieving the desired output from the hierarchical rule-based decision policy based on the user-facing explanation.

18. The computer system of claim 17, wherein the dependency graph comprises input data nodes describing the input case and a plurality of decision nodes describing respective rules of the hierarchical rule-based policy.

19. The computer system of claim 17, wherein the network of intermediate explanations comprises an intermediate explanation for a first decision node that is a conjunction of range constraints for the first decision node and range constraints for a second decision node that directly precedes the first decision node.

20. The computer system of claim 17, wherein computing of the network of intermediate explanations comprises computing a first intermediate explanation for an output node of the acyclic dependency graph and generating refined intermediate explanations of the first intermediate explanation for respective intermediate decision nodes from the output node to an input node of the acyclic dependency graph.
